(19) United States
(12) Patent Application Publication
(10) Pub. No.: US 2012/0070533 A1
(43) Pub. Date: Mar. 22, 2012

(54) SUPERFINE POWDERED STEVIA

(76) Inventor: Jingang Shi, Beijing (CN)

(21) Appl. No.: 13/215,362

(22) Filed: Aug. 23, 2011

Related U.S. Application Data
(60) Provisional application No. 61/376,008, filed on Aug. 23, 2010.

(51) Int. Cl. A23L 1/236; A23G 3/36; A23G 4/06

(52) U.S. Cl. 426/3; 428/402; 426/548

(57) ABSTRACT

The invention describes micronized stevia compositions having particle sizes of less than about 20 microns which helps to decrease the aftertaste associated with typical stevia compositions having particulate sizes of greater than about 20 microns.

### CROSS REFERENCE TO RELATED APPLICATIONS

This application claims benefit under 35 U.S.C. §119(e) to U.S. Provisional Patent Application Serial No. Appln. No. 61/376,008, filed Aug. 23, 2010, the contents of which is incorporated herein by reference in its entirety

### FIELD OF THE INVENTION

The present invention discloses powdered stevia extracts that have a particle size of less than about 20 microns (μm) or less.

### BACKGROUND OF THE INVENTION

Stevia is a genus of about 240 species of herbs and shrubs in the sunflower family (Asteraceae), native to subtropical and tropical South America and Central America.

The species Stevia rebaudiana Bertoni, commonly known as sweet leaf, sugarleaf, or simply stevia, is widely grown for its sweet leaves. The leaves have traditionally been used as a sweetener. Steviosides and rebaudiosides are the major constituents of glycosides found in the leaves of the stevia plant.

Over 100 phytochemicals have been discovered in stevia. It is rich in terpenes and flavonoids. Of these eight glycosides, stevioside is considered the sweetest and has been tested to be approximately 300 times sweeter than sugar. Stevioside, comprising 6-18% of the stevia leaf, is also the most prevalent glycoside in the leaf. Other sweet constituents include steviolbioside, rebaudiosides A-E, and dulcoside A.

The main plant chemicals in stevia include: apigenin, austroinulin, avicularin, beta-sitosterol, caffeic acid, campesterol, caryophyllene, centaureidin, chlorogenic acid, chlorophyll, cosmosiin, cynaroside, daucosterol, diterpene glycosides, dulcosides A-B, foeniculin, formic acid, gibberellic acid, gibberellin, indole-3-acetonitrile, isoquercitrin, isosteviol, jhanol, kaempferol, kaurene, lupeol, luteolin, polystachoside, quercetin, quercitrin, rebaudioside A-F, scopoletin, sterebin A-H, steviol, steviolbioside, steviolmonoside, stevioside, stevioside a-3, stigmasterol, umbelliferone, and xanthophylls.

Stevia extracts generally contain a high percentage of the glycosides of the diterpene steviol. The leaves of stevia rebaudiana contain 10 different steviol glycosides. Steviol glycosides are considered high intensity sweeteners (about 250-300 times that of sucrose) and have been used for several years in a number of countries as a sweetener for a range of food products. Stevioside and rebaudioside A are the principal sweetening compounds and generally accompanied by smaller amounts of other steviol glycosides. The taste quality of rebaudioside A is better than stevioside, because of increased sweetness and decreased bitterness (Phytochemistry 68, 2007, 1855-1863).

The structures and chemical abstract service registry numbers for steviol and its glycosides that are the main sweetening agents of the additive steviol glycosides are shown below:

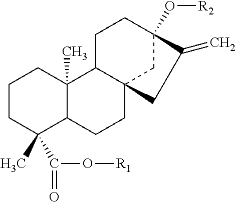

| | Compound name | C.A.S. No. | R₁ | R₂ |
|---|---|---|---|---|
| 1 | Steviol | 471-80-7 | H | H |
| 2 | Steviolbioside | 41093-60-1 | H | β-Glc-β-Glc(2→1) |
| 3 | Stevioside | 57817-89-7 | β-Glc | β-Glc-β-Glc(2→1) |
| 4 | Rebaudioside A | 58543-16-1 | β-Glc | β-Glc-β-Glc(2→1) |
| | | | | \| |
| | | | | β-Glc(3→1) |
| 5 | Rebaudioside B | 58543-17-2 | H | β-Glc-β-Glc(2→1) |
| | | | | \| |
| | | | | β-Glc(3→1) |
| 6 | Rebaudioside C | 63550-99-2 | β-Glc | β-Glc-β-Rha(2→1) |
| | | | | \| |
| | | | | β-Glc(3→1) |
| 7 | Rebaudioside D | 63279-13-0 | β-Glc-β-Glc | β-Glc-β-Glc(2→1) |
| | | | (2→1) | \| |
| | | | | β-Glc(3→1) |
| 8 | Rebaudioside E | 63279-14-1 | β-Glc-β-Glc | β-Glc-β-Glc(2→1) |
| | | | (2→1) | |
| 9 | Rebaudioside F | 438045-89-7 | β-Glc | β-Glc-β-Xyl(2→1) |
| | | | | \| |
| | | | | β-Glc(3→1) |
| 10 | Rubusoside | 63849-39-4 | β-Glc | β-Glc |
| 11 | Dulcoside A | 64432-06-0 | β-Glc | β-Glc-α-Rha(2→1) |

Steviol glycoside preparations are generally white to light yellow powders that are freely soluble in water and ethanol. The powders can be odorless or have a slight characteristic odor. Aqueous solutions are 200 to 300 times sweeter than sucrose under identical conditions. With its extracts having up to 300 times the sweetness of sugar, stevia has garnered attention with the rise in demand for low-carbohydrate, low-sugar food alternatives.

Medical research has also shown possible benefits of stevia in treating obesity and high blood pressure. Because stevia has a negligible effect on blood glucose, it is attractive as a natural sweetener to people on carbohydrate-controlled diets.

As a sweetener and sugar substitute, rebaudioside A has a slower onset and longer duration than that of sugar, and be deemed very close to sucrose, although some of its extracts may have a bitter or licorice-like aftertaste at high concentrations. All steviol glycosides are bitter, some in less degree and some in greater degree.

Therefore, a need exists for a sweetener that overcomes one or more of the current disadvantages noted above.

### BRIEF SUMMARY OF THE INVENTION

The present invention surprisingly provides the ability to mask, decrease or eliminate bitterness in an otherwise sweet composition. In particular, compositions that contain steviol glycosides typically have a bitter aftertaste. The improved taste of the compositions of the invention are based, in part, by the reduction in particle size of stevia extracts that contain steviol glycosides to a particle size of less than about 20 microns or less, more particularly less than about 15 microns, even more particularly less than about 10 microns, in particular less than about 5 microns and in one aspect less than about 2 microns.

Commercially available stevia extracts have particle size compositions of about 24 microns or larger. Such extracts typically have a bitterness and/or licorice like aftertaste that can be unpleasant to an individual. It has been surprisingly found that powdering, grinding, (milling), etc. of stevia extracts to a point where the particle size of the particles is less than about 20 microns, overcomes, decreases, eliminates or masks the aftertaste typically associated with stevia extracts.

Up until the time of the present disclosure, it had not been appreciated that the reduction in the particle size distribution of stevia extracts could overcome the aftertaste effects of steviol glycosides, such as rebaudioside A. Rebaudioside A is a major component of stevia extracts. Up until the present invention, the focus of research in stevia sweetener preparations has been to produce, isolate and purify rebaudioside A. There has been no appreciation that a decrease in particle size of the stevia extract would have such a dramatic effect on the reduction of aftertaste of stevia while still retaining increased sweetness (as compared to sugar or other readily available artificial or natural sweeteners).

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the detailed descriptions are to be regarded as illustrative in nature and not restrictive.

### BRIEF DESCRIPTION OF THE FIGURES

FIG. 1 provides a commercial stevia extract with 92% rebaudioside A content, having a mean particle size distribution of 24.49 microns.

FIG. 2 provides the commercial stevia extract of FIG. 1 after micronization to provide a mean particle size distribution of 2.72 microns.

FIG. 3 provides an electron micrograph of the stevia extract of FIG. 1.

FIG. 4 provides an electron micrograph of the micronized stevia extract of FIG. 2.

### DETAILED DESCRIPTION

In the specification and in the claims, the terms “including” and “comprising” are open-ended terms and should be interpreted to mean “including, but not limited to . . . . “These terms encompass the more restrictive terms “consisting essentially of” and “consisting of.”

It must be noted that as used herein and in the appended claims, the singular forms “a”, “an”, and “the” include plural reference unless the context clearly dictates otherwise. As well, the terms “a” (or “an”), “one or more” and “at least one” can be used interchangeably herein. It is also to be noted that the terms “comprising”, “including”, “characterized by” and “having” can be used interchangeably.

Unless defined otherwise, all technical and scientific terms used herein have the same meanings as commonly understood by one of ordinary skill in the art to which this invention belongs. All publications and patents specifically mentioned herein are incorporated by reference in their entirety for all purposes including describing and disclosing the chemicals, instruments, statistical analyses and methodologies which are reported in the publications which might be used in connection with the invention. All references cited in this specification are to be taken as indicative of the level of skill in the art. Nothing herein is to be construed as an admission that the invention is not entitled to antedate such disclosure by virtue of prior invention.

The phrase “steviol glycosides” is recognized in the art and is intended to include the major and minor constituents of stevia. These include, but are not limited to components of stevia such as Steviol, Steviolbioside, Stevioside, Rebaudioside A (RA), Rebaudioside B (RB), Rebaudioside C (RC), Rebaudioside D (RD), Rebaudioside E (RE), Rebaudioside F (RF), Rubusoside and Dulcoside A (DA). Typically, stevia contains about 2-4% of rebaudioside A. Stevia extracts are typically prepared and isolated as solid materials that are particulate in nature. The size of the particulates can vary but are at least 24 microns or larger. As a consequence, it is quite surprising, unappreciated, and unpredicted that reduction of the size of the stevia extract particles could overcome the aftertaste and/or bitterness of the components of stevia extracts.

The phrase “stevia containing sweetener” is intended to include any composition that is prepared from a stevia plant, such as a stevia extract, or the individual components found in stevia. The sweetener can include one or more of the components associated with the stevia plant, such as those noted above.

A “stevia composition” as referred to herein, pertains to a material that includes one or more steviol glycosides found in the stevia plant.

In particular, the present invention provides stevia compositions that have a particle size distribution of less than about 20 microns, so as to reduce or eliminate or mask the after taste of a typical steviol glycoside composition. The stevia compositions of the invention, therefore, provide a sweetener that has an aftertaste that is reduced, eliminated or is imperceptible by an individual tasting the micronized/powdered stevia composition.

As a sweetener, sweet taste acceptance determines market value. Due to the decrease in the amount of RC and/or DA present in a stevia composition overcomes objectionable aftertaste. Sweetness is related to taste sensitivity. The ability to provide powdered stevia compositions with reduced or eliminated aftertaste or bitterness on an industrial scale will provide the opportunity to use these powdered stevia sweeteners as a significant sugar substitute.

Stevia extracts can be obtained from the stevia plant by extraction techniques and can be purchased from commercial sources.

The researchers of this invention found that grinding stevia extract particulates to a powdered composition having a particle size of less than about 20 microns in a food or beverage can improve the aftertaste, e.g., it is more similar to sucrose and has a less bitter aftertaste that stevia containing products having a particle size of 24 microns or larger.

It has been found that reduction of particle size of the stevia extract has a significant impact on the taste of the extract. In one aspect, the stevia extract is milled or ground to a powdered substance having a particle size of less than about 20 microns. In another aspect, the powdered stevia extract has a particle size of less than about 15 microns. In still another aspect, the powdered stevia extract has a particle size of less than about 10 microns. In still yet another aspect, the powdered stevia extract has a particle size of less than about 5 microns. In still another aspect, the powdered stevia extract has a particle size of less than about 2 microns. In yet another aspect, the powdered stevia extract has a particle size of less than about 1 micron.

In another embodiment, the stevia extract is milled or ground to a powdered substance having a mean particle size of less than about 20 microns. In another aspect, the powdered stevia extract has a mean particle size of less than about 15 microns. In still another aspect, the powdered stevia extract has a mean particle size of less than about 10 microns. In still yet another aspect, the powdered stevia extract has a mean particle size of less than about 5 microns. In still another aspect, the powdered stevia extract has a mean particle size of less than about 2 microns. In yet another aspect, the powdered stevia extract has a mean particle size of less than about 1 micron.

When the particle size of the stevia extract is a “mean” particle size, then in various embodiments there are at least 50% of the particles that have a particle size of less than about 20 microns, more particularly, at least 60%, 70%, 80%, 90%, 90%, 95% or 99% of the particles have a particle size of less than about 20 microns.

In another aspect, when the mean particle size is less than about 15 microns, then at least 50% of the particles that have a particle size of less than about 15 microns, and more particularly, at least 60%, 70%, 80%, 90%, 90%, 95% or 99% have a particle size of less than about 15 microns.

In still another aspect, when the mean particle size is less than about 10 microns, then at least 50% of the particles that have a particle size of less than about 10 microns, and more particularly, at least 60%, 70%, 80%, 90%, 90%, 95% or 99% have a particle size of less than about 10 microns.

In still yet another aspect, when the mean particle size is less than about 5 microns, then at least 50% of the particles that have a particle size of less than about 5 microns, and more particularly, at least 60%, 70%, 80%, 90%, 90%, 95% or 99% have a particle size of less than about 5 microns.

In still another aspect, when the mean particle size is less than about 2 microns, then at least 50% of the particles that have a particle size of less than about 2 microns, and more particularly, at least 60%, 70%, 80%, 90%, 90%, 95% or 99% have a particle size of less than about 2 microns.

In still another aspect, when the mean particle size is less than about 1 microns, then at least 50% of the particles that have a particle size of less than about 1 microns, and more particularly, at least 60%, 70%, 80%, 90%, 90%, 95% or 99% have a particle size of less than about 1 microns.

The compositions noted above, as either having a particle size less than about a particular value or a mean particle size less than about a particular value, have a reduced or are devoid of an aftertaste or bitterness.

The compositions also noted above, as either having a particle size less than about a particular value or a mean particle size less than about a particular value, have a reduced or are devoid of an aftertaste or bitterness as compared to an unground stevia extract.

The compositions also noted above, as either having a particle size less than about a particular value or a mean particle size less than about a particular value, have a reduced or are devoid of an aftertaste or bitterness as compared to a stevia extract having a particle size of greater than 24 microns.

The stevia compositions noted herein can be used as a sugar substitute alone or in combination with a food product.

The stevia compositions noted herein can be used in beverages, broths, and beverage preparations selected from the group comprising carbonated, non-carbonated, frozen, semi-frozen (“slush”), non-frozen, ready-to-drink, concentrated (powdered, frozen, or syrup), dairy, non-dairy, herbal, non-herbal, caffeinated, non-caffeinated, alcoholic, non-alcoholic, flavored, non-flavored, vegetable-based, fruit-based, root/tuber/corm-based, nut-based, other plant-based, cola-based, chocolate-based, meat-based, seafood-based, other animal-based, algae-based, calorie enhanced, calorie-reduced, and calorie-free products, optionally dispensed in open containers, cans, bottles or other packaging. Such beverages and beverage preparations can be in ready-to-drink, ready-to-cook, ready-to-mix, raw, or ingredient form and can use the stevia composition as a sole sweetener or as a co-sweetener.

The stevia compositions noted herein can be used in foods and food preparations (e.g. sweeteners, soups, sauces, flavorings, spices, oils, fats, and condiments) from dairy-based, cereal-based, baked, vegetable-based, fruit-based, root/tuber/corm-based, nut-based, other plant-based, egg-based, meat-based, seafood-based, other animal-based, algae-based, processed (e.g. spreads), preserved (e.g. meals-ready-to-eat rations), and synthesized (e.g. gels) products. Such foods and food preparations can be in ready-to-eat, ready-to-cook, ready-to-mix, raw, or ingredient form and can use the stevia compositions as a sole sweetener or as a co-sweetener.

The stevia compositions noted herein can be used in candies, confections, desserts, and snacks selected from the group comprising dairy-based, cereal-based, baked, vegetable-based, fruit-based, root/tuber/corm-based, nut-based, gum-based, other plant-based, egg-based, meat-based, seafood-based, other animal-based, algae-based, processed (e.g. spreads), preserved (e.g. meals-ready-to-eat rations), and synthesized (e.g. gels) products. Such candies, confections, desserts, and snacks can be in ready-to-eat, ready-to-cook, ready-to-mix, raw, or ingredient form, and can use the stevia compositions as a sole sweetener or as a co-sweetener.

The stevia compositions noted herein can be used in prescription and over-the-counter pharmaceuticals, assays, diagnostic kits, and therapies selected from the group comprising weight control, nutritional supplement, vitamins, infant diet, diabetic diet, athlete diet, geriatric diet, low carbohydrate diet, low fat diet, low protein diet, high carbohydrate diet, high fat diet, high protein diet, low calorie diet, non-caloric diet, oral hygiene products (e.g. toothpaste, mouthwash, rinses, floss, toothbrushes, other implements), personal care products (e.g. soaps, shampoos, rinses, lotions, balms, salves, ointments, paper goods, perfumes, lipstick, other cosmetics), professional dentistry products in which taste or smell is a factor (e.g. liquids, chewables, inhalables, injectables, salves, resins, rinses, pads, floss, implements), medical, veterinarian, and surgical products in which taste or smell is a factor (e.g. liquids, chewables, inhalables, injectables, salves, resins, rinses, pads, floss, implements), and pharmaceutical compounding fillers, syrups, capsules, gels, and coating products.

The stevia compositions noted herein can be used in consumer goods packaging materials and containers selected from the group comprising plastic film, thermoset and thermoplastic resin, gum, foil, paper, bottle, box, ink, paint, adhesive, and packaging coating products.

The stevia compositions noted herein can be used in goods including sweeteners, co-sweeteners, coated sweetener sticks, frozen confection sticks, medicine spoons (human and veterinary uses), dental instruments, pre-sweetened disposable tableware and utensils, sachets, edible sachets, potpourris, edible potpourris, artificial flowers, edible artificial flowers, clothing, edible clothing, massage oils, and edible massage oils.

The stevia compositions can also be used with “artificial sweeteners”. Artificial sweeteners are those, other than sucrose, such as cyclamates and salts thereof, sucralose, aspartame, saccharin and salts thereof, stevia (Truvia™), rebaudioside A, xylitol, acesulfame-K, neotame, N—[N-[3-(3-hydroxy-4-methoxyphenyl)propyl]-alpha-aspartyl]-L-phenylalanine 1-methyl ester (hereinafter abbreviated as “ANS9801”), glycyrrhizin, thaumatin, monellin and the like. The stevia compositions noted herein masks, reduces or eliminates the aftertaste associated with the artificial sweetener, such that the taste of like that of sugar.

The following paragraphs enumerated consecutively from 1 through 77 provide for various aspects of the present invention. In one embodiment, in a first paragraph (1), the present invention provides a composition, comprising a stevia extract having a particle size of less than about 20 microns (μm).

2. The composition of paragraph 1, wherein the particle size is less than about 15 microns.

3. The composition of paragraph 1, wherein the particle size is less than about 10 microns.

4. The composition of paragraph 1, wherein the particle size is less than about 5 microns.

5. The composition of paragraph 1, wherein the particle size is less than about 2 microns.

6. The composition of any of paragraphs 1 through 5, wherein the stevia extract comprises one or more of rebaudioside A, rebaudioside B, rebaudioside C, rebaudioside D, rebaudioside E, rebaudioside F, stevioside, steviolbioside, dulcoside A or mixtures thereof.

7. The composition of any of paragraphs 1 through 6, wherein the stevia extract contains not less than 50% steviol glycosides.

8. The composition of any of paragraphs 1 through 6, wherein the stevia extract contains not less than 60% steviol glycosides.

9. The composition of any of paragraphs 1 through 6, wherein the stevia extract contains not less than 70% steviol glycosides.

10. The composition of any of paragraphs 1 through 6, wherein the stevia extract contains not less than 80% steviol glycosides.

11. The composition of any of paragraphs 1 through 6, wherein the stevia extract contains not less than 90% steviol glycosides.

12. The composition of any of paragraphs 1 through 6, wherein the stevia extract contains not less than 95% steviol glycosides.

13. The composition of any of paragraphs 1 through 6, wherein the stevia extract contains not less than 96% steviol glycosides.

14. The composition of any of paragraphs 1 through 6, wherein the stevia extract contains not less than 97% steviol glycosides.

15. The composition of any of paragraphs 1 through 6, wherein the stevia extract contains not less than 98% steviol glycosides.

16. The composition of any of paragraphs 1 through 6, wherein the stevia extract contains not less than 99% steviol glycosides.

17. The composition of any of paragraphs 1 through 16, wherein the composition is devoid of an aftertaste or bitterness.

18. The composition of any of paragraphs 1 through 16, wherein the composition has a reduced aftertaste or bitterness as compared to an unground stevia extract.

19. The composition of any of paragraphs 1 through 16, wherein the composition is devoid of an aftertaste or bitterness as compared to a stevia extract having a particle size of greater than 24 microns.

20. The composition of any paragraphs 1 through 19, further comprising a solid or liquid food stuff.

21. The composition of paragraph 20, wherein the foodstuff is chewing gum, cake, bread, sandwich, pie, bacon, sausage, fish flake, chip, meat, milk product, snack food, biscuit, cookie, candy, fondant, chocolate, chocolate flavored coating, pizzas, popcorn, trifle, dessert, cream puff, chewing gum, creams, health bars, confections, or glaze.

22. A composition, comprising a stevia extract having a mean particle size of less than about 20 microns (μm).

23. The composition of paragraph 22, wherein at least 50% of the particles have a particle size of less than about 20 microns.

24. The composition of paragraph 22, wherein at least 60% of the particles have a particle size of less than about 20 microns.

25. The composition of paragraph 22, wherein at least 70% of the particles have a particle size of less than about 20 microns.

26. The composition of paragraph 22, wherein at least 80% of the particles have a particle size of less than about 20 microns.

27. The composition of paragraph 22, wherein at least 90% of the particles have a particle size of less than about 20 microns.

28. The composition of paragraph 22, wherein at least 95% of the particles have a particle size of less than about 20 microns.

29. The composition of paragraph 22, wherein at least 99% of the particles have a particle size of less than about 20 microns.

30. The composition of paragraph 22, wherein the mean particle size is less than about 15 microns.

31. The composition of paragraph 30, wherein at least 50% of the particles have a particle size of less than about 15 microns.

32. The composition of paragraph 30, wherein at least 60% of the particles have a particle size of less than about 15 microns.

33. The composition of paragraph 30, wherein at least 70% of the particles have a particle size of less than about 15 microns.

34. The composition of paragraph 30, wherein at least 80% of the particles have a particle size of less than about 15 microns.

35. The composition of paragraph 30, wherein at least 90% of the particles have a particle size of less than about 15 microns.

36. The composition of paragraph 30, wherein at least 95% of the particles have a particle size of less than about 15 microns.

37. The composition of paragraph 30, wherein at least 99% of the particles have a particle size of less than about 15 microns.

38. The composition of paragraph 22, wherein the mean particle size is less than about 10 microns.

39. The composition of paragraph 38, wherein at least 50% of the particles have a particle size of less than about 10 microns.

40. The composition of paragraph 38, wherein at least 60% of the particles have a particle size of less than about 10 microns.

41. The composition of paragraph 38, wherein at least 70% of the particles have a particle size of less than about 10 microns.

42. The composition of paragraph 38, wherein at least 80% of the particles have a particle size of less than about 10 microns.

43. The composition of paragraph 38, wherein at least 90% of the particles have a particle size of less than about 10 microns.

44. The composition of paragraph 38, wherein at least 95% of the particles have a particle size of less than about 10 microns.

45. The composition of paragraph 38, wherein at least 99% of the particles have a particle size of less than about 10 microns.

46. The composition of paragraph 22, wherein the mean particle size is less than about 5 microns.

47. The composition of paragraph 46, wherein at least 50% of the particles have a particle size of less than about 5 microns.

48. The composition of paragraph 46, wherein at least 60% of the particles have a particle size of less than about 5 microns.

49. The composition of paragraph 46, wherein at least 70% of the particles have a particle size of less than about 5 microns.

50. The composition of paragraph 46, wherein at least 80% of the particles have a particle size of less than about 5 microns.

51. The composition of paragraph 46, wherein at least 90% of the particles have a particle size of less than about 5 microns.

52. The composition of paragraph 46, wherein at least 95% of the particles have a particle size of less than about 5 microns.

53. The composition of paragraph 46, wherein at least 99% of the particles have a particle size of less than about 5 microns.

54. The composition of paragraph 22, wherein the mean particle size is less than about 2 microns.

55. The composition of paragraph 54, wherein at least 50% of the particles have a particle size of less than about 2 microns.

56. The composition of paragraph 54, wherein at least 60% of the particles have a particle size of less than about 2 microns.

57. The composition of paragraph 54, wherein at least 70% of the particles have a particle size of less than about 2 microns.

58. The composition of paragraph 54, wherein at least 80% of the particles have a particle size of less than about 2 microns.

59. The composition of paragraph 54, wherein at least 90% of the particles have a particle size of less than about 2 microns.

60. The composition of paragraph 54, wherein at least 95% of the particles have a particle size of less than about 2 microns.

61. The composition of paragraph 54, wherein at least 99% of the particles have a particle size of less than about 2 microns.

62. The composition of any of paragraphs 22 through 61, wherein the stevia extract comprises one or more of rebaudioside A, rebaudioside B, rebaudioside C, rebaudioside D, rebaudioside E, rebaudioside F, stevioside, steviolbioside, dulcoside A or mixtures thereof.

63. The composition of any of paragraphs 22 through 62, wherein the stevia extract contains not less than 50% steviol glycosides.

64. The composition of any of paragraphs 22 through 62, wherein the stevia extract contains not less than 60% steviol glycosides.

65. The composition of any of paragraphs 22 through 62, wherein the stevia extract contains not less than 70% steviol glycosides.

66. The composition of any of paragraphs 22 through 62, wherein the stevia extract contains not less than 80% steviol glycosides.

67. The composition of any of paragraphs 22 through 62, wherein the stevia extract contains not less than 90% steviol glycosides.

68. The composition of any of paragraphs 22 through 62, wherein the stevia extract contains not less than 95% steviol glycosides.

69. The composition of any of paragraphs 22 through 62, wherein the stevia extract contains not less than 96% steviol glycosides.

70. The composition of any of paragraphs 22 through 62, wherein the stevia extract contains not less than 97% steviol glycosides.

71. The composition of any of paragraphs 22 through 62, wherein the stevia extract contains not less than 98% steviol glycosides.

72. The composition of any of paragraphs 22 through 62, wherein the stevia extract contains not less than 99% steviol glycosides.

73. The composition of any of paragraphs 22 through 72, wherein the composition is devoid of an aftertaste or bitterness.

74. The composition of any of paragraphs 22 through 72, wherein the composition has a reduced aftertaste or bitterness as compared to an unground stevia extract.

75. The composition of any of paragraphs 22 through 72, wherein the composition is devoid of an aftertaste or bitterness as compared to a stevia extract having a particle size of greater than 24 microns.

76. The composition of any paragraphs 22 through 75, further comprising a solid or liquid food stuff.

77. The composition of paragraph 76, wherein the foodstuff is chewing gum, cake, bread, sandwich, pie, bacon, sausage, fish flake, chip, meat, milk product, snack food, biscuit, cookie, candy, fondant, chocolate, chocolate flavored coating, pizzas, popcorn, trifle, dessert, cream puff, chewing gum, creams, health bars, confections, or glaze.

The invention will be further described with reference to the following non-limiting Examples. It will be apparent to those skilled in the art that many changes can be made in the embodiments described without departing from the scope of the present invention. Thus the scope of the present invention should not be limited to the embodiments described in this application, but only by embodiments described by the language of the claims and the equivalents of those embodiments. Unless otherwise indicated, all percentages are by weight.

### Examples

A sample of rebaudioside A extract was ground to a fine powder using a ball and mill system.

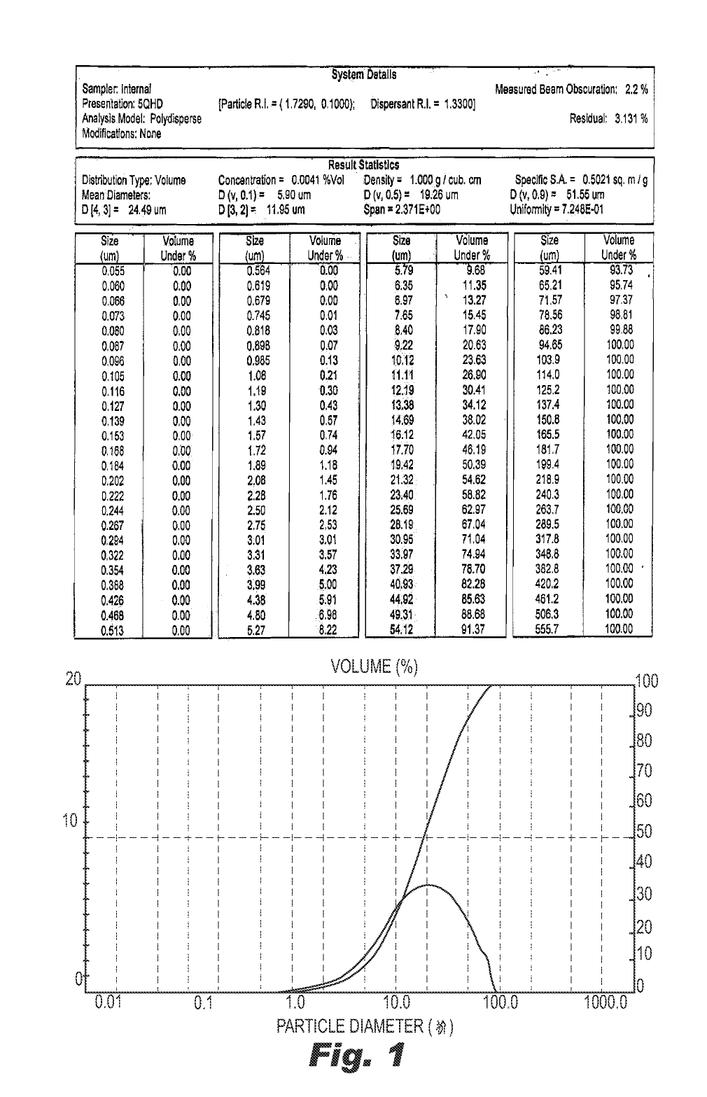

Sample 1, unground stevia extract. FIG. 1 provides a commercial stevia extract with 92% rebaudioside A content, having a mean particle size distribution of 24.49 microns.

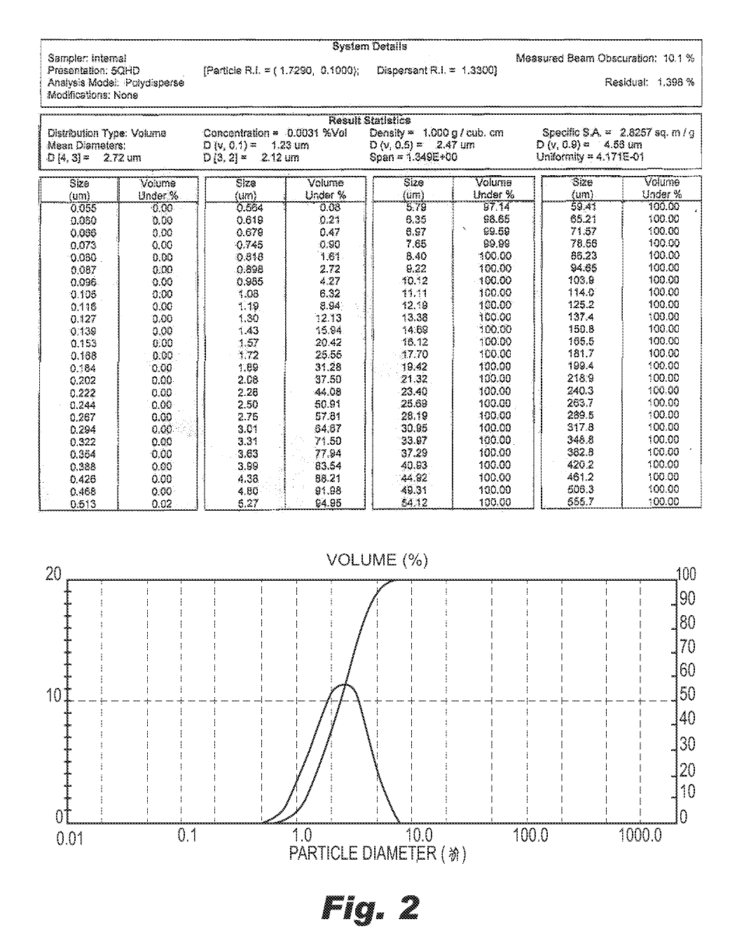

Sample 2, ground stevia extract. FIG. 2 provides the commercial stevia extract of FIG. 1 after micronization to provide a mean particle size distribution of 2.72 microns.

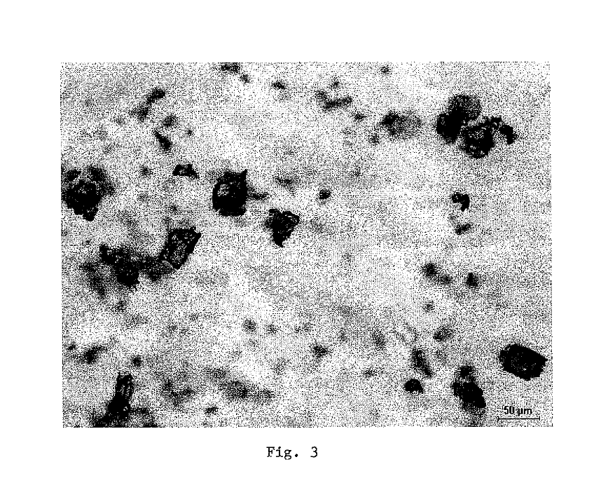

FIG. 3 provides an electron micrograph of the stevia extract of FIG. 1.

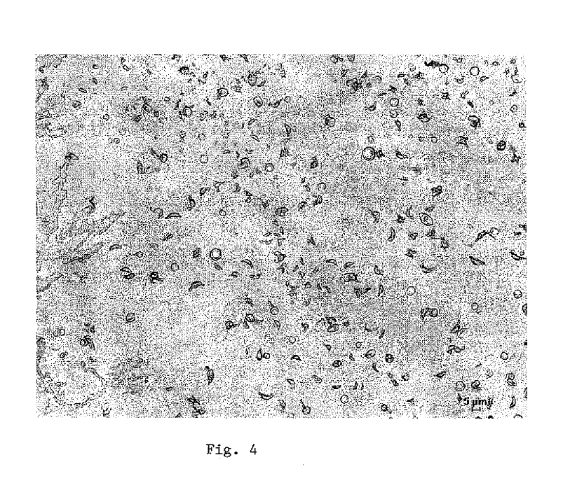

FIG. 4 provides an electron micrograph of the micronized stevia extract of FIG. 2.

Sensory evaluation of the two samples show sample 2 has much less bitterness than sample 1. It is considered that this result was previously unappreciated prior to the discovery of the invention.

Chewing Gum

Chewing gum samples were prepared according to commercial products (sweetener is Sorbitol).

The amount of sweetener added to chewing gum formula: 0.2% by weight.

Sorbitol was replaced with sample 1 and 2 (described above) in the formula noted below:

Sample A: used sample 1 as sweetener

Sample B: used sample 2 as sweetener

Sample C: commercial product

10 people were chosen to make the sensory evaluation, and the results as below:

The taste profiles of sample A was very good. Sweetness is high but lasted for only about 3 min.

The sweetness of sample B lasted for a longer period of time, more than 15 min.

Sample A and B had better sweetness profiles than sample C.

Conclusion: superfine powder of rebaudioside A provides an increased sensory profile in comparison to sorbitol. This is advantageous for a chewing gum product.

Although the present invention has been described with reference to preferred embodiments, persons skilled in the art will recognize that changes may be made in form and detail without departing from the spirit and scope of the invention. All references cited throughout the specification, including those in the background, are incorporated herein in their entirety. Those skilled in the art will recognize, or be able to ascertain, using no more than routine experimentation, many equivalents to specific embodiments of the invention described specifically herein. Such equivalents are intended to be encompassed in the scope of the following claims.

What is claimed is:

1. A composition, comprising a stevia extract having a mean particle size of less than about 20 microns (μm).

2. The composition of claim 1, wherein at least 50% of the particles have a particle size of less than about 20 microns.

3. The composition of claim 1, wherein at least 60% of the particles have a particle size of less than about 20 microns.

4. The composition of claim 1, wherein at least 70% of the particles have a particle size of less than about 20 microns.

5. The composition of claim 1, wherein at least 80% of the particles have a particle size of less than about 20 microns.

6. The composition of claim 1, wherein at least 90% of the particles have a particle size of less than about 20 microns.

7. The composition of claim 1, wherein at least 95% of the particles have a particle size of less than about 20 microns.

8. The composition of claim 1, wherein at least 99% of the particles have a particle size of less than about 20 microns.

9. The composition of claim 1, wherein the composition is devoid of an aftertaste or bitterness as compared to a stevia extract having a particle size of greater than 24 microns.

10. The composition of claim 2, wherein the composition is devoid of an aftertaste or bitterness as compared to a stevia extract having a particle size of greater than 24 microns.

11. The composition of claim 3, wherein the composition is devoid of an aftertaste or bitterness as compared to a stevia extract having a particle size of greater than 24 microns.

12. The composition of claim 4, wherein the composition is devoid of an aftertaste or bitterness as compared to a stevia extract having a particle size of greater than 24 microns.

13. The composition of claim 5, wherein the composition is devoid of an aftertaste or bitterness as compared to a stevia extract having a particle size of greater than 24 microns.

14. The composition of claim 6, wherein the composition is devoid of an aftertaste or bitterness as compared to a stevia extract having a particle size of greater than 24 microns.

15. The composition of claim 7, wherein the composition is devoid of an aftertaste or bitterness as compared to a stevia extract having a particle size of greater than 24 microns.

16. The composition of claim 8, wherein the composition is devoid of an aftertaste or bitterness as compared to a stevia extract having a particle size of greater than 24 microns.

17. The composition of claim 1, further comprising a solid or liquid food stuff.

18. The composition of claim 17, wherein the foodstuff is chewing gum, cake, bread, sandwich, pie, bacon, sausage, fish flake, chip, meat, a milk product, a snack food, a biscuit, cookies, candy, fondant, chocolate, chocolate flavored coatings, pizzas, popcorn, trifle, desserts, cream puffs, creams, health bars, confections, or glazes.

19. The composition of claim 7, further comprising a solid or liquid food stuff.

20. The composition of claim 19, wherein the foodstuff is chewing gum, cake, bread, sandwich, pie, bacon, sausage, fish flake, chip, meat, a milk product, a snack food, a biscuit, cookies, candy, fondant, chocolate, chocolate flavored coatings, pizzas, popcorn, trifle, desserts, cream puffs, creams, health bars, confections, or glazes.
